(19) United States
(12) Patent Application Publication
(10) Pub. No.: US 2019/0370897 A1
(43) Pub. Date: Dec. 5, 2019

(54) ONLINE PLATFORM FOR MULTI-ATTRIBUTE MATCHING AND TWO-PARTY VALIDATION USING PAYMENT CARD NETWORKS

(71) Applicant: MASTERCARD INTERNATIONAL INCORPORATED, Purchase, NY (US)

(72) Inventors: Peter J. GROARKE, Dublin (IE); Ahmed HOSNY, Portlaoise (IE); Mena Michael ESKANDER, Dublin (IE)

(21) Appl. No.: 15/992,591

(22) Filed: May 30, 2018

(51) Int. Cl. G06Q 40/04; G06Q 20/34; G06Q 20/40

(52) U.S. Cl. CPC G06Q 40/04; G06Q 20/4014; G06Q 20/356

(57) ABSTRACT

A computer-implemented method includes registering at least a first merchant and a second merchant, the registering including a consent process for payment card network access. The registering enables a registered merchant to post equity financing auctions and to bid on posted equity financing auctions. When a posting for an equity finance request is received from a registered first merchant, a validated aggregate historical data for the registered first merchant can be obtained from the payment card network. When a bid, which includes an amount of finance offered and requested equity, is received on the equity finance request from a registered second merchant, a set of transaction data for the registered second merchant is obtained from the payment card network and a score is generated for the registered second merchant based on conditions in the equity finance request using the set of transaction data and the bid.

### BACKGROUND

An online platform refers to the hardware and software architecture that serves as the foundation of the environment supported by the online platform. Numerous web-based technologies are involved in supporting an online platform and online platforms can be created for various applications. Where the online platform functions to provide an online marketplace or online auction, the online platform can enable two (or more) parties to interact with each other to conduct transactions.

Online platforms can include or leverage, via application programming interfaces, functionality including search or browse support, which can enable users of the online platform to find items, refine search results, and filter search results based on aspects or field values. Online platforms also often include mechanisms to increase trust between parties using the online platform. These mechanisms may include a credit verification service and providing feedback and rating functionality.

### BRIEF SUMMARY

An online platform for multi-attribute matching and two-party validation using payment card networks is described. The described systems and methods can be applied to facilitate corporate equity financing. For example, an online portal to a validation and matching system is provided. As a tool, the validation and matching system leverages a payment card network to verify parties involved in equity financing as well as score and rank potential investors. In some cases, the validation and matching system further supports an online auction of equity ownership in an enterprise where the bids involve cash investment, services, property, or a combination thereof.

A computer-implemented method for an online auction system can perform multi-attribute matching and two-party validation using payment card networks by registering at least a first merchant and a second merchant, the registering enabling a registered merchant to post equity financing auctions and to bid on posted equity financing auctions, wherein the registering comprises performing a consent process for data that can be retrieved from the payment card network; receiving a posting for an equity finance request from a registered first merchant; automatically performing a matching process with respect to all registered merchants that consented to the matching process; notifying any registered merchants that satisfy the matching process of the equity finance request; requesting, via an application programming interface (API) of a payment card network, a validated aggregate historical data for the registered first merchant; storing, in a storage resource, the validated aggregate historical data for the registered first merchant associated with the equity finance request; receiving a bid on the equity finance request from a registered second merchant, the bid comprising an amount of finance offered and requested equity; requesting, via the API of the payment card network, a set of transaction data for the registered second merchant; and generating a score for the registered second merchant based on conditions in the equity finance request using the set of transaction data and the bid.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an operating environment of an online platform for multi-attribute matching and two-party validation using payment card networks.

FIG. 2 illustrates example processes that may be carried out by the described system.

FIGS. 3A-3D illustrate an example scenario of multi-attribute matching and two-party validation for equity financing using a payment card network.

FIG. 4 illustrates an example online auction system.

FIG. 5 illustrates modules of an example online auction system.

FIGS. 6A-6E illustrate processes carried out by the modules of the example online auction system.

FIG. 7 illustrates a flowchart of an example auction.

FIG. 8 illustrates components of a computing system that may be used in certain embodiments described herein.

### DETAILED DESCRIPTION

An online platform for multi-attribute matching and two-party validation using payment card networks is described. The described systems and methods can be applied to facilitate corporate equity financing. For example, an online portal to a validation and matching system is provided. As a tool, the validation and matching system leverages a payment card network to verify parties involved in equity financing as well as score and rank potential investors. In some cases, the validation and matching system further supports an online auction of equity ownership in an enterprise where the bids involve cash investment, services, property, or a combination thereof.

Payment card networks are the networks supporting payment card schemes. A payment card scheme involves relationships between member banks, including issuer banks and acquirer banks, and relationships between merchants and their acquirer banks. Payment card schemes facilitate movement of payment transactions on a payment network and allow clearing and settlement to occur between the relevant parties.

A payment card network includes an electronic system that can execute decisions with respect to where a bank's partnered credit cards can be used (e.g., whether a card can be used to pay a particular merchant) and can facilitate the payments made from a credit card user to the merchant through the bank. The bank (also referred to as a financial institution), as credit card issuer and account servicer, may be a separate entity from the entity operating the payment card network or may be the same entity.

A given member bank undergoes due diligence to gain access to the payment network. In addition, a merchant undergoes due diligence to gain access via their acquirer bank to the payment card network. The due diligence can include whether a merchant is listed on a terminated merchant file or other list indicating high-risk behavior. This file or list can be leveraged by the online platform through an application programming interface with the transaction intermediary (which manages or has access to the file or list for a payment network).

Corporate equity financing, or simply “equity financing”, refers to the process of raising capital through the sale of equity or quasi-equity instruments corresponding to shares in an enterprise. In equity financing, the investing party receives a stake in the enterprise in exchange for the funds. In contrast, in debt financing, the investing party, or lender, provides funds that are expected to be paid back.

In equity financing, due diligence may be carried out to determine trustworthiness of the parties. In addition to due diligence with respect to the funding component for the parties involved—for example whether the company requesting investment is suitable for investing and whether the investing party is trustworthy, it can be desirable to determine whether other characteristics of the parties are suitable for components of the relationship.

There are many considerations involved in corporate equity financing, including, but not limited to, the round of financing, the type of stocks offered, whether the equity is provided in exchange for cash investment or in exchange for services or property (intellectual property, real property or personal property), or a combination thereof, and the scope of information rights and participation rights in the company requesting investment. Most activities with respect to discovery and diligence are typically carried out manually by the parties, with certain activities performed by attorneys, accountants, and investigation firms.

The described systems and techniques can, in some cases, provide improved usability of software supporting diligence efforts as well as support fewer processing steps in searching for relevant data about the parties to the equity financing deal.

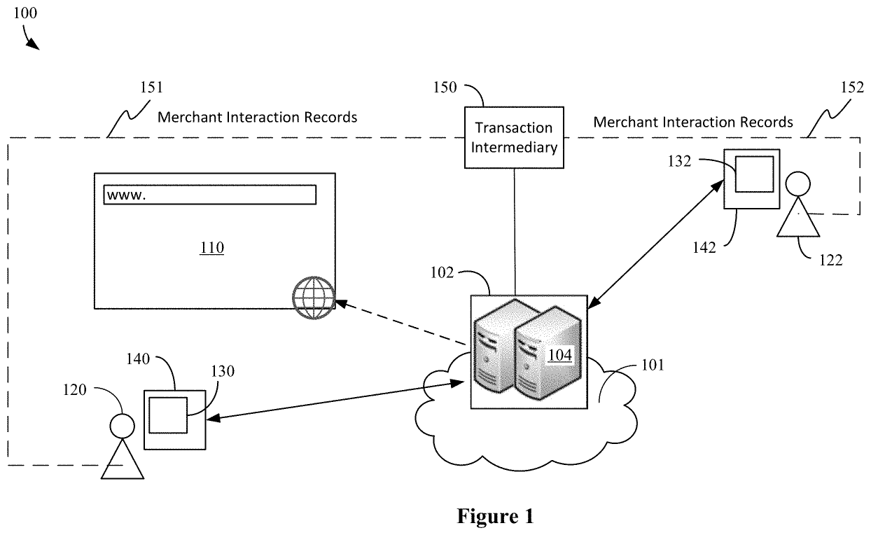

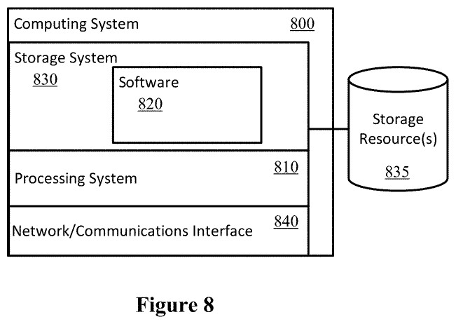

FIG. 1 illustrates an operating environment of an online platform for multi-attribute matching and two-party validation using payment card networks. Referring to FIG. 1, an operating environment 100 can include an online service platform 101 with an online auction system 102 through which multi-attribute matching and two-party validation using payment card networks can be supported. The online service platform 101 (and online auction system 102) can be implemented using one or more servers 104, including, or in communication with, a web server that supports and maintains a website 110. Servers 104 may be embodied such as described with respect to system 800 of FIG. 8 and include storage resources (not shown). Website 110 can provide a user interface to the online auction system 102 of the online service platform 101 that can perform the multi-attribute matching and two-party validation processes. Merchant users, for example a first merchant 120 and a second merchant 122 can access the online auction system through, for example, web browser applications 130, 132 rendering website 110 from respective computing devices 140, 142.

System 102 communicates with a transaction intermediary 150 to obtain, upon consent of the merchants, validation of the parties. The transaction intermediary 150 can also be a resource, upon consent of the merchants, for information used by the system 102 to perform the multi-attribute matching. The transaction intermediary 150, which may be or may access a payment card network, separately maintains relationships with the merchants and can store and aggregate transaction data carried out by other people's interactions with the merchants (e.g., merchant interaction records 151 of the first merchant 120 and merchant interaction records 152 of the second merchant 122). Merchant interaction records refer to the credit or debit card financial transaction messages associated with purchases from the merchant by cardholders. A credit or debit card financial transaction message can consist of several transaction characteristics. These transaction characteristics include, but are not limited to, acquirer identifier/card acceptor identifier the combination of which uniquely identifies the merchant, merchant address, merchant type/goods type (e.g., toys, jewelry, restaurant), transaction environment (mail order/telephone order, POS (point of sale) terminal), cardholder base currency (USD, Euro, Yen, etc.), local transaction date-time, and amount of the transaction.

The transaction intermediary 150 can store merchant interaction records associated with the corresponding merchant. Thus, transaction data associated with a merchant can include, but is not limited to, a merchant address, a merchant type, a goods type, a transaction environment, a cardholder base currency, a local transaction date-time, an amount of the transaction, and the like.

Some of the information stored by the transaction intermediary 150 can be obtained from the financial transaction message directly or in combination with other database information (e.g., full address can be looked up in a contact DB which may have full address and/or GPS data). Cardholder origin can be determined through POS transaction information and cardholder base currency (along with merchant location information). For example, by partitioning the POS transactions by cardholder base currency and aggregating the date/time over all merchants in an area.

Communication to and from system 102 may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

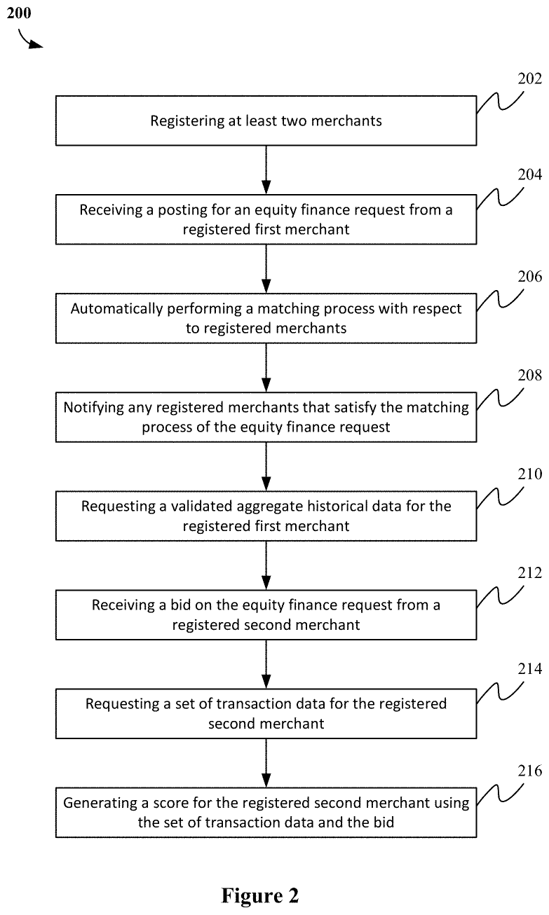

FIG. 2 illustrates example processes that may be carried out by the described system. Processes 200 carried out by the system 102 can include registering (202) at least a first merchant and a second merchant. Once registered, a merchant can post equity financing auctions and/or bid on posted equity financing auctions. The registration process can include performing a consent process for data that can be retrieved from the payment card network. Consent is obtained for scenarios including, but not limited to, use of data by the system to carry out the validation and/or matching processes and permissions for certain users of the system to view selected data. The consent process may involve the merchant providing consent directly to the payment card network for releasing information to the system 102.

The type of information and the scenarios in which that information is permitted to be used (e.g., the particular consent provided) can be selected by the merchant. In some cases, the registration process can require different information (and consent) depending on whether the merchant desires to make equity finance requests or to bid on requests. In some cases, the consent process can include receiving approval from the first merchant to retrieve the validated aggregate historical data from the payment card network and to share the validated aggregate historical data with one or more merchants that bid on the equity finance request. In some cases, the consent process can include receiving approval from the second merchant to retrieve historical data from the payment card network and to share certain information to the registered first merchant. In some cases, both types of approvals may be received from a same merchant.

In some cases, the first communication with the payment card network (e.g., via the transaction intermediary 150) is via a consent API, which may permit the access of transaction history. The system 102 can check that authorization has been granted by the party for the type of request (there may be a broad authorization granted for all auction activities, authorization for a specific auction, or authorization just for use by the system 102. In some cases, the original granting of consent occurs through the consent API (for a particular merchant and a given period of time) and the particular authorizations are stored at the intermediary 150 for later retrieval or the information is pulled at the time consent is given and stored at the system 102.

The system can store the registration information (and any optional transaction data) in a storage resource in any suitable data structure including, but not limited to, a table, a directory, or a graph.

Processes 200 can also include receiving (204) a posting for an equity finance request from a registered first merchant. The equity finance request can include an amount of capital, which may be in the form of a minimum value, a range of values, a maximum value, or even a value associated with requested services (e.g., where services are requested in exchange for equity), and a proposed stake (e.g., the proposed equity trade that the requester is willing to exchange), which may be in the form of a minimum value, a range of values, or a maximum value. In some cases, an end time for the posting/auction may be part of the equity finance request.

The posting can further include a number of conditions and optionally one or more minimum attributes. For example, the conditions of the equity finance request can include, but are not limited to, having sales in a certain geography, having a specific turnover or turnover increase within a particular time period, having a certain number of cardholders using a specific currency or from a given location, or a combination thereof. The one or minimum attributes can correspond to a condition, the bid, and/or the equity trade. For example, the requester can arrange for minimum values that create a threshold of who would qualify to bid. As an illustration, the requester may have a condition that a bidder have sales in a certain geography and use a minimum parameter value of the amount of sales that are acceptable. The conditions and/or minimum attributes may be pre-conditions for bidding, may be used as score factors (and optionally weighted), or both. In some cases, only those merchants that satisfy the conditions and/or minimum attributes may view the auction/equity finance request.

In some cases, the system can automatically perform a matching process (206) with respect to all registered merchants that consented to the matching process. In some cases, the consent for the matching process is carried out during the registration process. Then, the system may determine which merchants consented to the matching process by, for example, querying a storage resource storing merchant registration information. In some cases, the matching process can include retrieving, from a payment card network (e.g., via transaction intermediary 150), a set of corresponding transaction data for each of the registered merchants that consented to the matching process, generating a matching score to the equity request based on the conditions in the equity finance request for each of the registered merchants using their set of corresponding transaction data, and determining whether or not the registered merchant satisfied the conditions in the equity finance request using the matching score. Any registered merchants that satisfy the matching process can be notified (208) of the equity finance request.

The system requests (210) a validated aggregate historical data for the registered first merchant from the payment card network. The request can be via an API of the payment card network. The validated aggregate historical data for the registered first merchant can be included as part of the equity finance request in order to facilitate the validation of the requesting merchant to a bidding merchant. In some cases, the validated aggregate historical data includes an indication as to whether the merchant is on a terminated merchant file or other list indicating high-risk behavior. The validated data for the registered first merchant may be available upon viewing the request or in response to a request for validation of the requestor by the bidding merchant.

In some cases, the validated aggregate historical data for the registered first merchant can be stored in a storage resource and associated with the equity finance request. Historical data can include historical cleared transactions such as a previous month or a yearly period through which one could use as a measure to determine a merchant's current and future revenues. In some cases, the system receives a verification request by the registered second merchant for verifying the registered first merchant; and in response to receiving the verification request. obtains the validated aggregate historical data for the registered first merchant and provides the validated aggregate historical data to the registered second merchant for verifying the registered first merchant.

Whether a merchant is notified via the notification operation 208 or becomes aware of an equity finance request in another manner (e.g., by searching the site, by receiving outside knowledge), the system can receive (212) a bid on the equity finance request from a registered second merchant. The bid can include an amount of finance offered and requested equity in return for that investment. In some cases, services or other non-monetary capital can be included in the bid. Unlike in conventional sales or bidding, the described system generates a score for the bid using information not directly provided by the bidder. Rather, the system requests (214) a set of transaction data for the registered second merchant; and generates (216) a score for the registered second merchant based on conditions in the equity finance request using the set of transaction data and the bid. The transaction data for the registered second merchant can be obtained, for example, via an API of a payment card network. The set of transaction data can include a merchant address for the registered second merchant, a merchant type of the registered second merchant and aggregate data for a goods type, a transaction environment, a cardholder base currency, a local transaction date-time, an amount of transaction, or a combination thereof.

Generating (216) the score for the registered second merchant based on the conditions in the equity finance request using the set of transaction data and the bid can include determining whether information in the set of transaction data satisfies one or more of the conditions in the equity finance request, each of the one or more conditions having a weight value; and calculating a condition score based on each satisfied condition and its corresponding weight value; and calculating the score for the registered second merchant from the condition score and the bid. The weight values may have been set by the requester when entering the equity finance request. In some cases, the weights are set to 1 (e.g., no weight applied).

As mentioned above, the conditions of the equity finance request can include having sales in a certain geography, having a specific turnover or turnover increase within a particular time period, having a certain number of cardholders using a specific currency or from a given location, or a combination thereof.

In some cases, the system may support bids from non-merchants. In one of such implementations, the non-merchant bidder can register in the system similar to the merchant registration process. Permissions may be obtained for accessing transaction data of the non-merchant in order to assess credit worthiness and/or other validating information. Registered non-merchant bidders may bid on equity requests, and to the extent their personal transaction data is relevant to the conditions of the bid, can have such data used in generating a score.

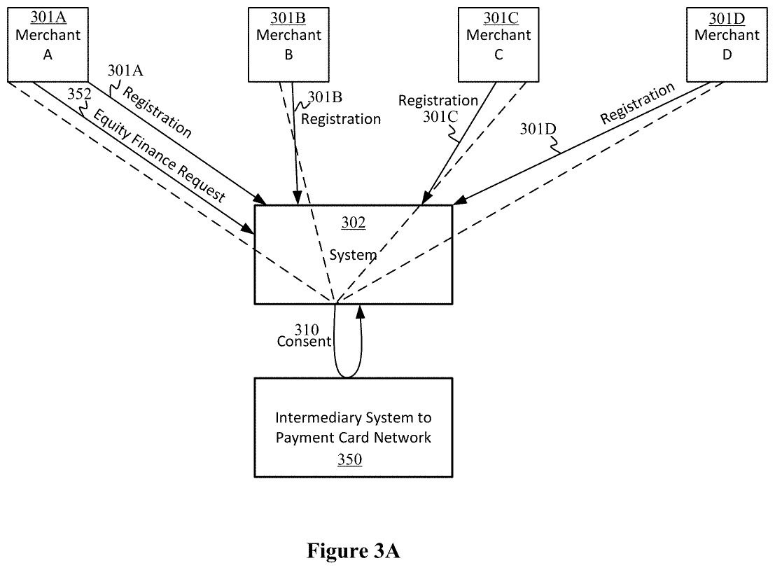

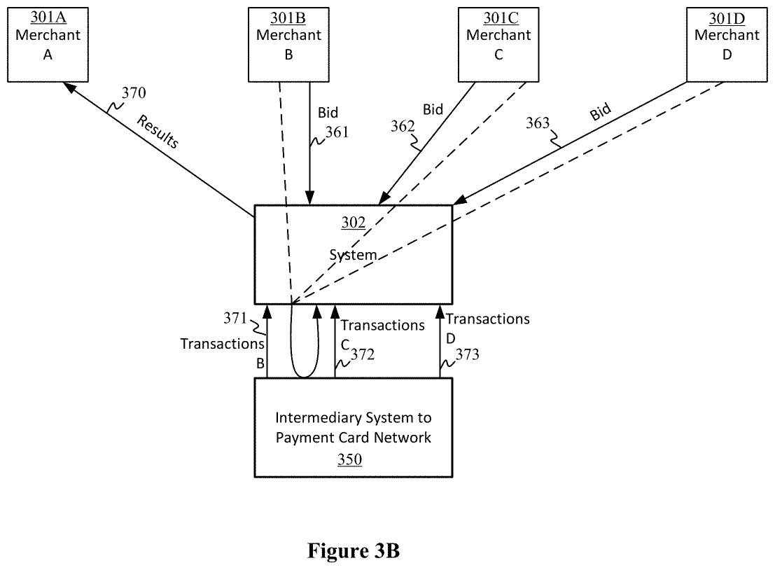

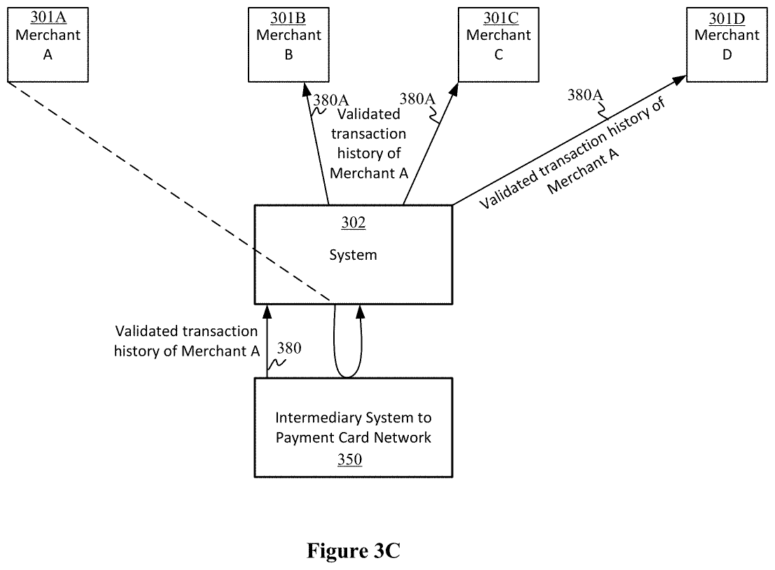

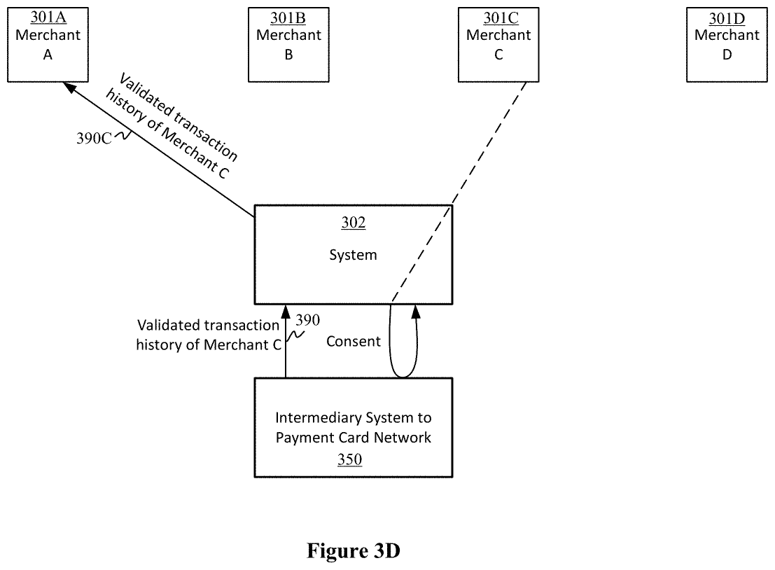

FIGS. 3A-3D illustrate an example scenario of multi-attribute matching and two-party validation for equity financing using a payment card network. Referring to FIG. 3A, Merchants (e.g., Merchant A 300A, Merchant B 300B, Merchant C 300C, Merchant D 300D) can register (301A, 301B, 301C, 301D) with the online auction system 302, for example, via processes 202 described with respect to FIG. 2. Consent 310 for information from the payment card network can be managed directly or indirectly (e.g., as a passthrough) through system 302 to the intermediary system 350 to the payment card network. In the example scenario, Merchant A 300A is Bloggs Toys based in Missouri that wishes to expand into the state of Kansas. They require corporate finance to expand, but an important additional consideration for them would be a financer having a distribution network in Kansas. They post details of the Equity Finance Auction to the online auction system 302 with an equity finance request 352 that includes a requested capital and a proposed equity trade. They also include conditions such as financer must have n number of Point of Sale locations in the state of Kansas, financer must have a certain level of Turnover or turnover delta over a period of time, and financer must have a certain number of customers in a given region.

Referring to FIG. 3B, a number of competing bids can be received by the system 350. Here three bids, a first bid 361 from Merchant B 300B, a second bid 362 from Merchant C 300C, and a third bid 363 from Merchant D 300D were received by the close date. In the example scenario, Merchant B 300B is B Corp with a first bid 361 of $200,000 financing for 20% equity, Merchant C 300C is C Toys Corp with a second bid 362 of $250,000 financing for 25% equity, and Merchant D 300D is D Corp with a third bid 363 of $350,000 financing for 10% equity. Although a single value for the financing and equity is described, the bids may include a range of values. The system 302 generates scores for each of these Merchant bids and provides the results 370 to Merchant A 300A.

As described with respect to process 216 of FIG. 2, the scores generated by system 302 take into account not just the bids themselves, but also additional information obtained from the payment card network. The system requests transaction data for each of the bidding Merchants and, using the transaction data (371, 372, 373), matches appropriate transaction data to the conditions/attributes of the bid. In some cases, classification algorithms are used. In some cases, clustering algorithms are used (e.g., to determine regional information such as how close geographically activities have occurred to a particular geographical location or to each other).

In the example scenario, although D Corp (Merchant D 300D) offered the most finance for the least equity, which contributes positively to their score, their score is not as high as would be expected from just the bid since their transaction data 373 indicates a poor distribution network of Toys within Kansas. B Corp (Merchant B 300B) offered good financial terms and their transaction data 371 indicates a reasonable sales distribution in Kansas state. However, C Toys Corp (Merchant C 300C) was indicated by their transaction data 372 to have the most geographically distributed network in Kansas and that they have an increasing turnover in areas closer to the border with Missouri. In addition, by using transaction data for Merchant A (not shown), the system 302 is able to evaluate that C Toys Corp had monthly sales for the last year that complement Bloggs Toys (e.g., C Toys has busy months when Missouri sales are lower). These factors may contribute to C Toys Corp have the highest score.

Referring to FIG. 3C, as a first part of the two-party validation capability, the system 302 can obtain validated transaction history 380 of Merchant A and provide that information (as validated transaction history of Merchant A 380A) in accordance with the consent parameters. That is, in some cases, the consent parameters may indicate that anyone who can view the auction can receive the information of the validated transaction history 380A and, in some other cases, the consent parameters may indicate that only selected ones of other merchants may receive the information of the validated transaction history 380A. The selected ones may be all or a subset of bidders. In the example illustrated in FIG. 3C, all three bidders received the validated transaction history of Merchant A.

Referring to FIG. 3D, the second part of the two-party validation capability includes providing validated transaction history 390 or other approved-by-bidding-Merchant transaction information to the requesting Merchant. For example, Merchant A 300A may want to accept the bid 362 from Merchant C 300C, but wants to verify that Merchant C 300C is likely to be trustworthy. Merchant A 300A can view the validated transaction history 390 (in the form of validated transaction history 390C) in response to requesting the transaction history or at the time of receiving the bid.

The described online platform with validation and matching functionality is suitable to support discovery and diligence activities with respect to corporate equity financing or other scenarios involving at least two parties that each use payment card schemes.

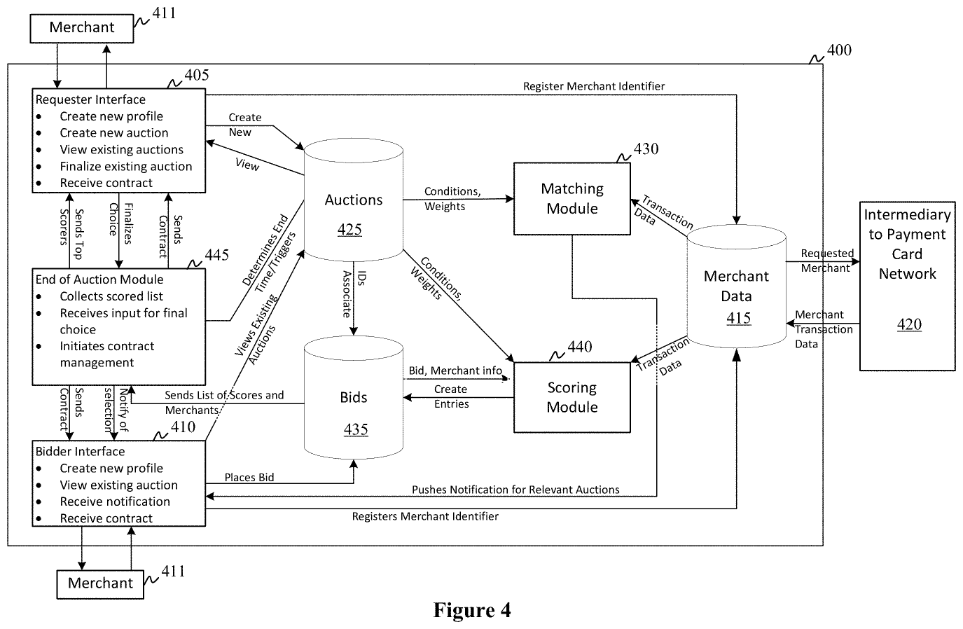

FIG. 4 illustrates an example online auction system. Referring to FIG. 4, an online auction system 400 can provide a requestor interface 405 and a bidder interface 410. The requester interface 405 can support functionality such as creating a new profile, creating a new auction, viewing existing auctions, and finalizing an existing auction (e.g., selecting a winner). In some cases, where the system can support brokering the exchange, the interface 405 can include functionality for viewing, editing and signing contracts for the exchange. The bidder interface 410 can support functionality such as creating a new profile, viewing an existing auction, searching auctions, and receiving notifications of auctions. In some cases, where the system can support brokering the exchange, the interface 410 can include functionality for viewing, editing and signing contracts for the exchange. A merchant 411 can access and use either interface. The creation of the new profile can include a registration process (e.g., such as described with respect to FIG. 2) and the Merchant (with identifier) can be stored in a merchant data resource 415. In some cases, Merchant transaction data (e.g., aggregated history data) can be obtained from the intermediary 420 and stored in the merchant data resource 415. The stored data is anonymized such that individual cardholder information is not included in the merchant data.

The requester interface 405 can be used to receive equity finance requests (e.g., creating a new auction). The equity finance request, associated conditions, minimum attributes, and any weights can be stored in an auctions resource 425. The auctions resource 425 may store present and past auctions.

A matching module 430 can receive the auctions information from the auctions resource 425 and the transaction data from the merchant data resource 415 and determine which of the registered merchants who consented for notifications may be eligible for (or find relevant) bidding on an equity finance request (associated with an auction). In some cases, the output of the matching module can be the one or more Merchants that are determined to be eligible. A notification module (not shown) can receive the list of the one or more Merchants and identify the contact information to notify the one or more Merchants of the equity finance request. In the example, a push notification for relevant auctions can be provided via the bidder interface 410. The matching module 430 may be triggered to operate when a new auction is added to the auctions resource 425 or when a Merchant requests a match.

The bidder interface 410 can be used to receive bids. The bids can be stored in a bids resource 435. A scoring module 440 receives the bids from the bids resource 435 for a particular auction, along with the conditions and optional weights stored in the auctions resource 425. The scoring module 440 further receives transaction data from the merchant data resource 415. The scoring module 440 can generate scores for each bid based on the transaction data of the Merchant and update the entries in the bid resource 435.

The scoring module 440 can be triggered, for example, when a bid is placed by a merchant, upon request of a user (e.g., bidder or requester), or at the end of the auction. The trigger information may be stored in the auction resource 425 (e.g., for the case where an end time is stored as part of the auction information).

In some cases, when an associated end time for a particular auction is reached, an end-of-auction module 445 can be executed. The end-of-auction module 445 can collect the scored list from the bids resource 435. In some cases, the end-of-auction module 445 can compare and rank the bids based on the one or more minimum parameters of the auction and provide the bids to the requester interface 405. When a selection of a bidder is made through the requester interface 405, the end-of-auction module 445 can notify the selected bidder of their selection via the bidder interface 410. The end-of-auction module 445 can also initiate contract management. For example, in the event of a successful bid, the system 400 or the intermediary 420 can act as a broker and electronically exchange contracts. The intermediary 420 could facilitate the equity transfer via an existing money network.

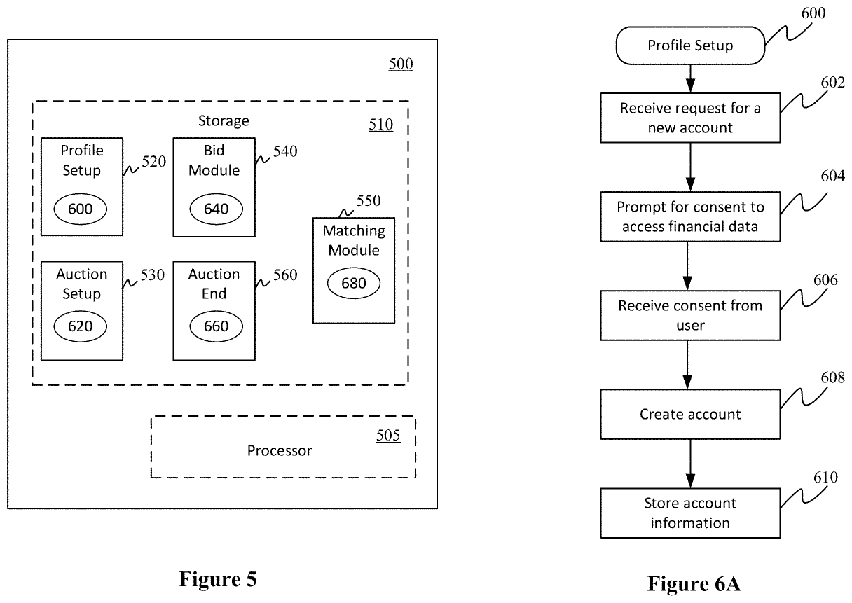

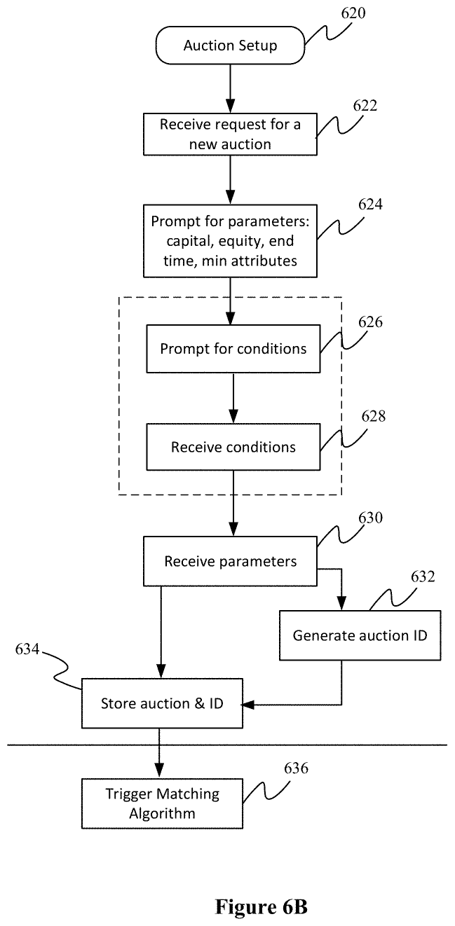

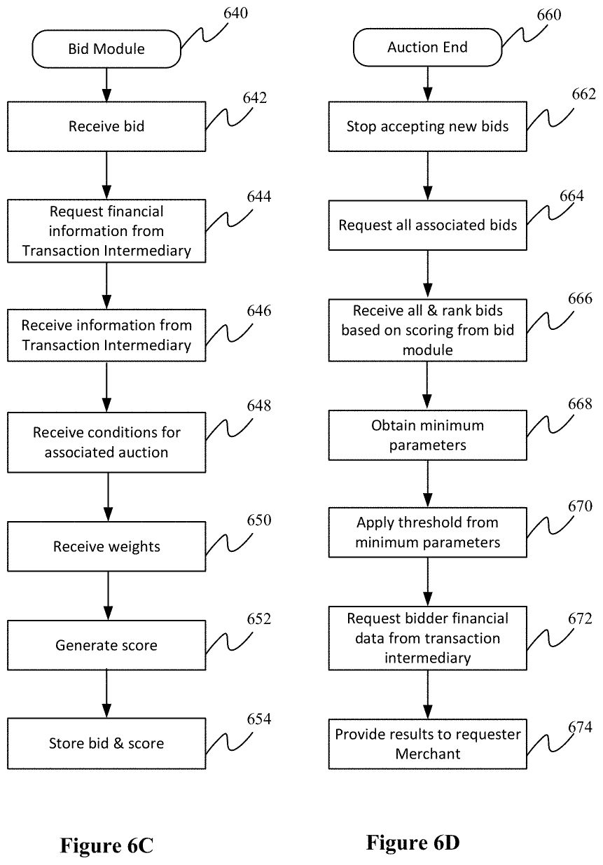

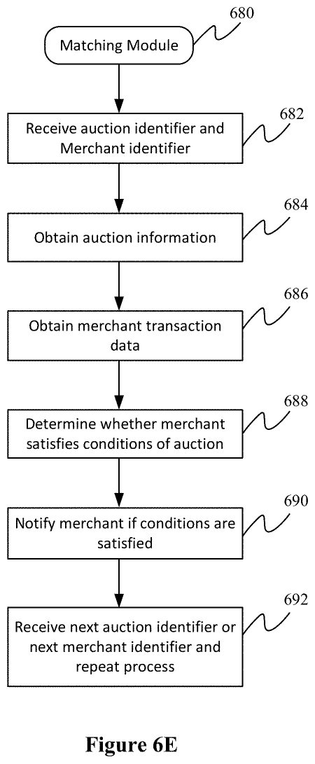

FIG. 5 illustrates modules of an example online auction system; and FIGS. 6A-6E illustrate processes carried out by the modules of the example online auction system. Referring to FIG. 5, an online auction system 500, which may be embodied as described with respect to system 800 of FIG. 8, can include a processor 505 and storage 510 storing software, including a profile setup module 520 (which can perform process 600), an auction setup module 530 (which can perform process 620), a bid module 540 (which can perform process 640), an auction end module 560 (which can perform process 660), and a matching module 550 (which can perform process 680).

Referring to FIG. 6A, the profile setup process 600 may be initiated when a merchant registers with the system and can begin with receiving (602) a request for a new account and information about the merchant. The system may, for example via an interface, prompt (604) for consent by the user for the system to be permitted to access financial data. After receiving (606) consent from the user, the system can create (608) the account (e.g., register the user) and store (610) the merchant information sufficient to identify the merchant to a payment card network.

Referring to FIG. 6B, the auction setup process 620 may be initiated when a registered merchant requests to create a new equity finance request. The system receives (622) the new equity finance request as a request for a new auction. In response to receiving the request for the new auction, the system can prompt (624) for parameters of the equity finance request, including desired capital, potential equity for exchange, end time for the auction, and optionally one or more minimum parameters. The system may also prompt for consent to display anonymized data about the merchant's transaction history for display to other prospective merchants. The system may further optionally prompt (626) for conditions for the equity finance request and receive the conditions (628). The system can receive (630) any parameters for the equity finance request input by the user. A unique identifier can be generated (632) for the auction and stored (634) associated with the received parameters and conditions. In some cases, the storing of the received parameters can directly or indirectly trigger (636) the matching algorithm (e.g., process 680).

Referring to FIG. 6C, the bid process 640 can begin by receiving (642) a bid from a registered merchant. This bid includes the capital offered and the equity requested. Financial information about the merchant is requested (644) from the trusted transaction intermediary (with consent); and the information is received (646). At the same time, prior to, or subsequent to the obtaining of the financial information, the system can obtain (648) the conditions corresponding to the auction to which the bid was applied. Weights for the conditions can also be received (650). Using the financial information, the conditions, and any weights, the system can generate (652) a score for the bid. The bid and its score are stored (654), for example, in a bid resource.

Referring to FIG. 6D, an auction end process 660 may initiate when the time for a particular auction is elapsed. At the end of the auction, the system can stop (662) accepting new bids. The stopping of acceptance of new bids may be reflected by removing the auction from a listing of auctions that could be visible in a graphical user interface to the online auction system or by including visual indicators or text to indicate that the auction period has ended. The module 560 can request (664) all associated bids that were stored during process 640. The received bids can be ranked (666) (and ordered) based on their corresponding scores. Any minimum parameters can be obtained (668) and used to determine and apply (670) a threshold to remove bids that do not satisfy the minimum parameters. For the bidders that satisfy the minimum parameters, the system can request bidder financial data from the transaction intermediary (672) and provide the results to the requester.

Referring to FIG. 6E, a matching process 680 is provided to facilitate the discovery of equity finance requests. the matching process 680 can identify Merchants that may satisfy the criteria of an equity finance request. In some cases, the matching process 680 is initiated by the end of the auction setup process 620. Merchants may request to be notified of investment opportunities and provide consent for the system to obtain their financial information from the payment card network. The matching module may receive (682) a specific auction to match to any consenting merchant or a specific merchant identifier to determine any matching auction from the currently available auctions. In either case, both an auction identifier and a merchant identifier are received by the matching module (the processes may simply diverge on subsequent calls where one identifier is kept constant and the other is changed). Of course, in some cases, the matching module is run until all auctions and/or merchants have been processed.

The module obtains (684) auction information associated with the auction identifier and obtains (686) merchant transaction data based on the auction information from the transaction intermediary; and determines (688) whether the identified merchant satisfies the conditions of the equity finance request. In some cases, the determination regarding satisfaction of the conditions can be similar to the scoring process, where the merchant transaction data is assigned a score, which may be optionally weighted. In some cases, the matching process further includes obtaining merchant transaction data of the requesting merchant (the merchant who submitted the equity finance request) and uses that information to further score the merchant associated with the merchant identifier (in a similar manner as in the example scenario where the system compared sales figures). Scores above a predetermined threshold may be considered to satisfy the conditions. The predetermined threshold may be set by the requestor or by the system. The merchant identified by the merchant identifier is notified (690) of the identified auction if conditions are determined to be satisfied. In some cases, the notification is carried out by another module and the output of the matching module is the merchant identifier and auction identifier. The next auction identifier or next merchant identifier is received (692) and the process repeated.

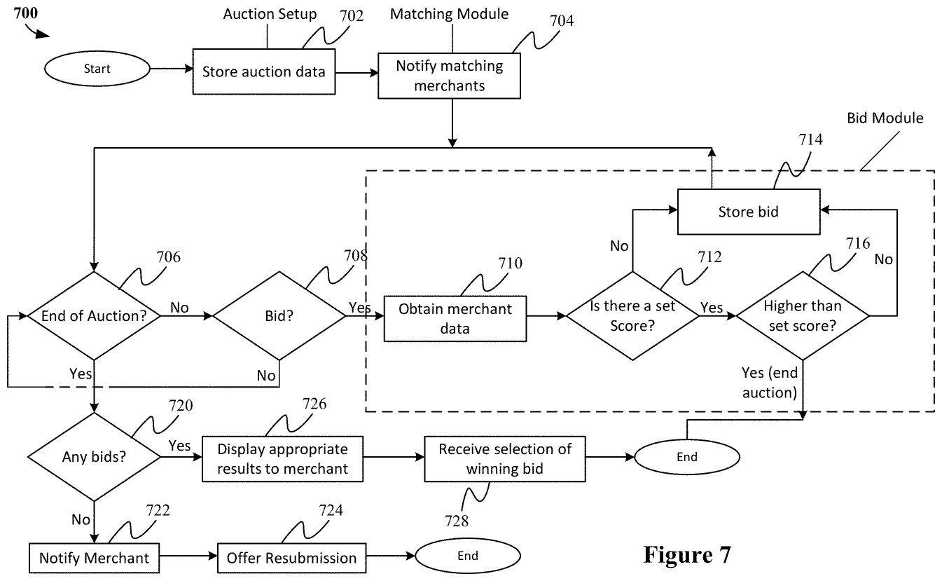

FIG. 7 illustrates a flowchart of an example auction. An auction for equity financing supported by the described online auction system can have three phases: setup, auction, and finalization. The auction 700 can be set up and auction data stored (702). The setup of the auction may be carried out via process 620 of auction setup module 530, as described with respect to FIGS. 5 and 6B. In some cases, the matching module 550 as described with respect to FIGS. 5 and 6E is triggered and merchants satisfying the conditions can be notified (704). Merchants may also learn of the existence of the auction by conducting a search of current auctions satisfying their queries or by viewing a list of auctions.

The auction process occurs during the time the auction is pending. For example, at any given time, the system checks whether or not a particular auction's time has elapsed (706) and if the auction has received any bids (708). If the time has not elapsed and there is a bid received by the system, the system obtains the merchant data (710) and can optionally check to see if a set score is present (712). The set score is a score that a requester may have set that would automatically satisfy their equity finance request. If there is no set score, the system can score and store the bid in the bid database (714). If there is a set score, the system can score the bid and compare the score to the set score (716). If the bid is higher than the strike score, the auction ends. If the bid is not higher than the strike score, the bid is stored with the other bids and the auction continues, waiting for either the end of auction or an incoming bid.

Once the end time of the auction has been reached (and the auction has not already ended due to a bid satisfying the set score), the finalization begins. The associated bids are pulled from the bid database, if any (720). If there are no bids, the requester may be notified (722) and prompted to create another listing for resubmission (724) to try again. If there are bids, the bids can be provided for display to the requester merchant (726), for example via a requester interface 405 as described in FIG. 4. The bids may be ranked and ordered by score. In some cases, the list is curated based on the one or more minimum parameters specified when the listing was created. The system can receive a selection of a winning bid (728).

FIG. 8 illustrates components of a computing system that may be used in certain embodiments described herein. Referring to FIG. 8, system 800 may be implemented within a single computing device or distributed across multiple computing devices or sub-systems that cooperate in executing program instructions. The system 800 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 800 can include a processing system 810, which may include one or more processors and/or other circuitry that retrieves and executes software 820 from storage system 830. Processing system 810 may be implemented within a single processing device but may also be distributed across multiple processing devices or sub-systems that cooperate in executing program instructions.

Storage system(s) 830 can include any computer readable storage media readable by processing system 810 and capable of storing software 820. Storage system 830 may be implemented as a single storage device but may also be implemented across multiple storage devices or sub-systems co-located or distributed relative to each other. Storage system 830 may include additional elements, such as a controller, capable of communicating with processing system 810. Storage system 830 may also include storage devices and/or sub-systems on which data is stored. System 800 may access one or more storage resources 835 (e.g., merchant data resource, bids resource, auctions resource, registration resource, and the like) or include the one or more storage resources 835 as part of storage system 830.

Software 820, including routines for performing processes 200, 600, 620, 640, 660, and 680, may be implemented in program instructions and among other functions may, when executed by system 800 in general or processing system 810 in particular, direct the system 800 or processing system 810 to operate as described herein. System 800 may represent any computing system on which software 820 may be staged and from where software 820 may be distributed, transported, downloaded, or otherwise provided to yet another computing system for deployment and execution, or yet additional distribution.

In embodiments where the system 800 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 840 may be included, providing communication connections and devices that allow for communication between system 800 and other computing systems (not shown) over a communication network or collection of networks (not shown) or the air.

In some embodiments, system 800 may host one or more virtual machines.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Embodiments may be implemented as a computer process, a computing system, or as an article of manufacture, such as a computer program product or computer-readable medium. Certain methods and processes described herein can be embodied as software, code and/or data, which may be stored on one or more storage media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system (and executable by a processing system) and encoding a computer program of instructions for executing a computer process. It should be understood that as used herein, in no case do the terms “storage media”, “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A computer-implemented method, comprising:
registering at least a first merchant and a second merchant, the registering enabling a registered merchant to post equity financing auctions and to bid on posted equity financing auctions, wherein the registering comprises performing a consent process for data that can be retrieved from a payment card network;
receiving a posting for an equity finance request from a registered first merchant;
automatically performing a matching process with respect to all registered merchants that consented to the matching process;
notifying any registered merchants that satisfy the matching process of the equity finance request;
requesting, via an application programming interface (API) of the payment card network, a validated aggregate historical data for the registered first merchant;
storing, in a storage resource, the validated aggregate historical data for the registered first merchant associated with the equity finance request;
receiving a bid on the equity finance request from a registered second merchant, the bid comprising an amount of finance offered and requested equity;
requesting, via the API of the payment card network, a set of transaction data for the registered second merchant; and
generating a score for the registered second merchant based on conditions in the equity finance request using the set of transaction data and the bid.

2. The method of claim 1, wherein the matching process comprises:
retrieving, from the payment card network, a set of corresponding transaction data for each of the registered merchants that consented to the matching process,
generating a matching score based on the conditions in the equity finance request for each of the registered merchants using their set of corresponding transaction data, and
determining whether or not the registered merchant satisfied the conditions in the equity finance request using the matching score.

3. The method of claim 1, wherein generating the score for the registered second merchant based on the conditions in the equity finance request using the set of transaction data and the bid comprises:
determining whether information in the set of transaction data satisfies one or more of the conditions in the equity finance request, each of the one or more of the conditions having a weight value;
calculating a condition score based on each satisfied condition and its corresponding weight value; and
calculating the score for the registered second merchant from the condition score and the bid.

4. The method of claim 3, wherein the conditions of the equity finance request comprise having sales in a certain geography, having a specific turnover or turnover increase within a particular time period, having a certain number of cardholders using a specific currency or from a given location, or a combination thereof.

5. The method of claim 3, wherein the set of transaction data comprises a merchant address for the registered second merchant, a merchant type of the registered second merchant and aggregate data for a goods type, a transaction environment, a cardholder base currency, a local transaction date-time, an amount of transaction, or a combination thereof.

6. The method of claim 1, further comprising:
receiving a verification request by the registered second merchant for verifying the registered first merchant;
obtaining the validated aggregate historical data for the registered first merchant; and
providing the validated aggregate historical data to the registered second merchant for verifying the registered first merchant.

7. The method of claim 1, wherein the consent process comprises:
receiving approval from the first merchant to retrieve the validated aggregate historical data from the payment card network and to share the validated aggregate historical data with one or more merchants that bid on the equity finance request, and
receiving approval from the second merchant to retrieve historical data from the payment card network and to share certain information to the registered first merchant.

8. The method of claim 1, wherein the equity finance request comprises a requested capital, a proposed equity trade, an end time for an auction, and the conditions.

9. The method of claim 8, wherein the equity finance request further comprises one or more minimum attributes.

10. A system comprising:
a processing system;
a storage system;
instructions stored on the storage system that when executed by the processing system direct the processing system to at least:
register at least a first merchant and a second merchant and perform a consent process for data that can be retrieved from a payment card network;
receive a posting for an equity finance request from a registered first merchant;
request, via an application programming interface (API) of the payment card network, a validated aggregate historical data for the registered first merchant;
store, in a storage resource of the storage system, the validated aggregate historical data for the registered first merchant associated with the equity finance request;
receive a bid on the equity finance request from a registered second merchant, the bid comprising an amount of finance offered and requested equity;
request, via the API of the payment card network, a set of transaction data for the registered second merchant; and
generate a score for the registered second merchant based on conditions in the equity finance request using the set of transaction data and the bid.

11. The system of claim 10, wherein the instructions further direct the processing system to:
automatically perform a matching process with respect to all registered merchants that consented to the matching process; and
notify any registered merchants that satisfy the matching process of the equity finance request.

12. The system of claim 11, wherein the instructions for the matching process direct the processing system to:
retrieve, from the payment card network, a set of corresponding transaction data for each of the registered merchants that consented to the matching process,
generate a matching score based on the conditions in the equity finance request for each of the registered merchants using their set of corresponding transaction data, and
determine whether or not any of the registered merchants satisfied the conditions in the equity finance request using the matching score.

13. The system of claim 10, wherein the instructions to generate the score for the registered second merchant based on the conditions in the equity finance request using the set of transaction data and the bid direct the processing system to:
determine whether information in the set of transaction data satisfies one or more of the conditions in the equity finance request, each of the one or more of the conditions having a weight value;
calculate a condition score based on each satisfied condition and its corresponding weight value; and
calculate the score for the registered second merchant from the condition score and the bid.

14. The system of claim 13, wherein the conditions of the equity finance request comprise having sales in a certain geography, having a specific turnover or turnover increase within a particular time period, having a certain number of cardholders using a specific currency or from a given location, or a combination thereof.

15. The system of claim 13, wherein the set of transaction data comprises a merchant address for the registered second merchant, a merchant type of the registered second merchant and aggregate data for a goods type, a transaction environment, a cardholder base currency, a local transaction date-time, an amount of transaction, or a combination thereof.

16. The system of claim 10, wherein the instructions further direct the processing system to:
receive a verification request by the registered second merchant for verifying the registered first merchant;
obtain the validated aggregate historical data for the registered first merchant; and
provide the validated aggregate historical data to the registered second merchant for verifying the registered first merchant.

17. The system of claim 10, wherein the instructions to perform the consent process direct the processing system to:
receive approval from the first merchant to retrieve the validated aggregate historical data from the payment card network and to share the validated aggregate historical data with one or more merchants that bid on the equity finance request, and
receive approval from the second merchant to retrieve historical data from the payment card network and to share certain information to the registered first merchant.

18. The system of claim 10, wherein the equity finance request comprises a requested capital, a proposed equity trade, an end time for an auction, and the conditions.

19. One or more storage media having instructions stored thereon that when executed by a processing system direct the processing system to at least:
register at least a first merchant and a second merchant and perform a consent process for data that can be retrieved from a payment card network;
receive a posting for an equity finance request from a registered first merchant;
request, via an application programming interface (API) of the payment card network, a validated aggregate historical data for the registered first merchant;
store, in a storage resource, the validated aggregate historical data for the registered first merchant associated with the equity finance request;
receive a bid on the equity finance request from a registered second merchant, the bid comprising an amount of finance offered and requested equity;
request, via the API of the payment card network, a set of transaction data for the registered second merchant; and
determine whether information in the set of transaction data satisfies one or more of the conditions in the equity finance request, each of the one or more of the conditions having a weight value;
calculate a condition score based on each satisfied condition and its corresponding weight value; and
calculate a score for the registered second merchant from the condition score and the bid to generate the score for the registered second merchant.

20. The media of claim 19, wherein the instructions further direct the processing system to:
retrieve, from the payment card network, a set of corresponding transaction data for each of any registered merchants that consented to a matching process,
generate a matching score based on the conditions in the equity finance request for each of the registered merchants that consented to the matching process using their set of corresponding transaction data,
determine whether or not any of the registered merchants that consented to the matching process satisfied the conditions in the equity finance request using the matching score; and
notify any registered merchants that satisfy the matching process of the equity finance request.
